(19) United States
(12) Patent Application Publication
(10) Pub. No.: US 2016/0054952 A1
(43) Pub. Date: Feb. 25, 2016

(54) APPARATUS AND METHOD FOR TIME SERIES QUERY PACKAGING

(71) Applicant: GE Intelligent Platforms, Inc., Charlottesville, VA (US)

(72) Inventors: Sunil MATHUR, Foxboro, MA (US); Jerry LIN, Niskayuna, NY (US)

(21) Appl. No.: 14/777,871

(22) PCT Filed: Mar. 18, 2013
(86) PCT No.: PCT/US2013/032823

§ 371 Date: Sep. 17, 2015

(51) Int. Cl. G06F 3/06; G06F 17/30

(52) U.S. Cl. CPC G06F 3/0649; G06F 17/30507; G06F 3/0605; G06F 3/0685

(57) ABSTRACT

A first query and a second query are received. The first query and the second query are evaluated and, based upon the evaluating, identifying first time series data required to fulfill the first query and second time series data required to fulfill the second query. An extent of overlap of the first time series data and the second time series data is determined. When the extent of overlap exceeds a predetermined threshold, the overlapping data is retrieved from a plurality of data storage devices in parallel, the data retrieved across all of the plurality of storage devices via a single read operation.

### CROSS REFERENCES TO RELATED APPLICATIONS

International application no. PCT/US2013/032803 filed Mar. 18, 2013 and published as WO2014149027 A1 on Sep. 25, 2014 and entitled “Apparatus and Method for Optimizing Time Series Data Storage Based Upon Prioritization”;

International application no. PCT/US2013/032802 filed Mar. 18, 2013 and published as WO2014149026 A1 on Sep. 25, 2014 and entitled “Apparatus and method for Memory Storage and Analytic Execution of Time Series Data”;

International application no. PCT/US2013/032810 filed Mar. 18, 2013 and published as WO2014149029 A1 on Sep. 25, 2014 and entitled “Apparatus and Method for Executing Parallel Time Series Data Analytics”;

International application no. PCT/US2013/032806 filed Mar. 18, 2013 and published as WO2014149028 A1 on Sep. 25, 2014 and entitled “Apparatus and Method for Optimizing Time Data Storage”;

International application no. PCT/US2013/032801 filed Mar. 18, 2013 and published as WO2014149025 A1 on Sep. 25, 2014 and entitled “Apparatus and Method for Optimizing Time Data Store Usage”;

are being filed on the same date as the present application, the contents of which are incorporated herein by reference in their entireties.

### BACKGROUND OF THE INVENTION

1. Field of the Invention

The subject matter disclosed herein relates to time series data, and, more specifically, to the efficient retrieval of time series data using queries.

2. Brief Description of the Related Art

Data is stored on data storage devices in a variety of different formats. Additionally, various types of data storage devices are used to store data and these data storage devices may vary in cost. In one example, data may be stored according to certain formats on high cost devices such as random access memories (RAMs). In other examples, data may be stored on low cost devices such as on hard disks.

One type of data that is stored at data storage devices is time series data. In one aspect, time series data is obtained by some type of sensor or measurement device and the data is then stored as a function of time. For example, a measurement sensor may take a reading of a parameter at predetermined time intervals, and each of the measurements is stored in memory. Since large amounts of data are typically involved with time series measurements, the storage and retrieval of this data may become inefficient.

A typical read query in traditional time-series databases usually includes two properties: a variable identifier to query and a query time range. There has been substantial research into query optimization of individual queries in such systems, where multiple queries are run one at a time. However, because the query engine lacks the awareness of common properties across multiple queries, it is not able to most efficiently utilize system resources to process many queries.

Most time-series applications often access the most recent data, i.e., multiple queries request data from a recent (overlapping) time span. This approach results in redundant I/O reads when reading the raw data from disk, because each query ends up accessing largely the same data.

One previous approach that attempted to alleviate this problem, was to scan an entire relational table. Instead of executing queries to retrieve the data, the queries were registered to receive raw data. Data was then streamed to these queries, and data that was relevant to one or more registered queries is selected. Unfortunately, this technique requires the reading of the entire table or partition in order to satisfy multiple queries at once.

For the above-mentioned reasons, previous approaches have suffered various problems. As a result, user dissatisfaction of these previous approaches has resulted.

### BRIEF DESCRIPTION OF THE INVENTION

Embodiments of the present invention package multiple queries as a set, for example, if they span roughly the same time metrics and/or duration. This results in the performance of a single shared data access operation before executing each query. Consequently, significantly improved multi-query performance is achieved.

For example, a user may want to run several analytics that require retrieving raw values from the last calendar day. Running each of these analytics individually would involve repeatedly retrieving the same 24 hours of raw data. Instead, embodiments of the present invention enable the analytics to be run in parallel such that, for instance, the 24 hours of data can be retrieved only once and shared among the analytics. By “analytics” and as used herein, it is meant any operations meant to analyze or manipulate the time series data, including but not limited to generating averages, calculating means and standard deviations, and identifying minimum and maximum values.

In many of these embodiments, a first query and a second query are received. The first query and the second query are evaluated and, based upon the evaluating, identifying first time series data required to fulfill the first query and second time series data required to fulfill the second query. An extent of overlap of the first time series data and the second time series data and identifying the overlapping data is determined. When the extent of overlap exceeds a predetermined threshold, the data required to fulfill both the first query and the second query is retrieved from a plurality of data storage devices in parallel, the data retrieved across all of the plurality of data storage devices via a single read operation.

In some aspects, the retrieved data is sorted for disbursement to the first query and the second query. In other aspects, the extent of overlap is determined based upon time ranges specified in the first query and the second query.

In some aspects, the first query or the second query comprises a read query. In other examples, the first query is from a first analytic and the second query is from a second analytic.

In other aspects, the query results (e.g., for the first query or the second query) are received. In some examples, a subset of the results is determined.

In others of these embodiments, an apparatus that is configured to execute multiple, time series data queries includes an interface and a processor. The interface has an input and an output and the input is configured to receive a first query and a second query.

The processor is coupled to the interface and is configured to evaluate the first query and the second query and, based upon the evaluation, identify first time series data required to fulfill the first query and second time series data required to fulfill the second query. The processor is further configured to determine an extent of overlap of the first time series data and the second time series data and identifying the overlapping data. The processor is further configured to, when the extent of overlap exceeds a predetermined threshold, retrieve the data required to fulfill both the first query and the second query from a plurality of data storage devices in parallel. The full data is retrieved across all of the plurality of data storage devices via a single read operation.

### BRIEF DESCRIPTION OF THE DRAWINGS

For a more complete understanding of the disclosure, reference should be made to the following detailed description and accompanying drawings wherein:

FIG. 1 comprises a block diagram of an embodiment to query packaging according to various embodiments of the present invention;

FIG. 2 comprises a flow chart of an embodiment for query packaging according to various embodiments of the present invention; and

FIG. 3 comprises a block diagram of an apparatus for query packaging according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

Embodiments of the present invention allow multiple queries to be packaged together providing a more efficient way of accessing data. In this respect, if it is determined that two or more queries overlap significantly, then a query planner apparatus computes the “union” of the individual queries, creating a single query plan that retrieves all the data that is needed by the two or more queries. When the results are returned, the query planner apparatus may select the proper subset of results to pass to each individual query.

As has been mentioned, running these queries individually as in previous systems results in redundant efforts to retrieve similar sets of time series data multiple times. In contrast, the embodiments of the present invention provided herein provide a mechanism to group queries together such that they share a common step of retrieving the time series data, significantly reducing the (input/output) I/O processing and thus the overall time to execute the set of queries. Put another way, because data movement and I/O is typically a significant amount of the processing time of a query, the present embodiments significantly improve query performance by minimizing redundant I/O operations.

Embodiments of the present invention allow for multiple queries to be submitted together to a query planner apparatus. The query planner apparatus evaluates the incoming queries and determines if there is significant overlap between them in terms of the data that will be retrieved. In one example, the determination of significant overlap may be based on the time ranges specified in the queries (e.g., require that queries share at least some minimum percentage of their respective time windows in order to be considered significantly overlapping). The query planner apparatus may, in addition, require that the queries share elements of the data model (e.g., require that the requested data of certain variables be for the same or similar variable groups/partitions in order for the queries to be considered overlapping).

Reducing redundant I/O steps results in quicker average query execution time for time series analytics, enabling analysts/users to identify and solve problems faster, particularly for remote monitoring and diagnostics. The present embodiments are also useful for providing very efficient visualization capabilities. Additionally, in many cases this frees up processing resources for other uses. A system implementing the present embodiments is faster and use less processing resources compared to other systems.

Embodiments of the present invention evaluate individually submitted jobs and determine if their level of overlap meets or exceeds the minimum threshold. If so, the many jobs can be repackaged into a single job for execution. This eliminates the need for repetitive I/O and has the added benefit of reducing the number of distinct jobs that have to be started within the system, another source of processing delay.

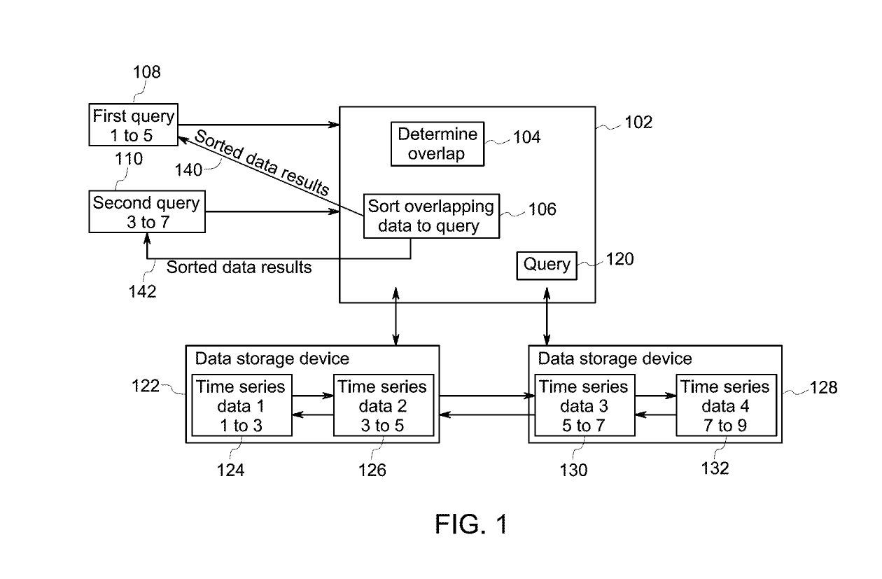

Referring now to FIG. 1, a system 100 that uses a query planner 102 is described. The query planner 102 includes a determine overlap module 104 and a sort overlapping data to query module 106. The determine overlap module 104 and the sort overlapping data to query module 106 may be implemented as programmed software operating on a processing device.

The query planner 102 receives a first query 108 and a second query 110. The determine overlap module 104 determines the extent of data overlap of the first query 108 and the second query 110. For example, time ranges on the queries 108 and 110 may specify a time period of interest for the queries. For instance, time periods of 1 to 5 may be specified in the first query 108 and a time range of 3 to 7 may be specified in the second query 110 (as used herein the units for these times are arbitrary, but can be second, milliseconds, and so forth to mention a few examples). The time overlap is 3 to 5 as between the queries. After the overlap is determined, a third query 120 is formed with the 1 to 7 time range. In some examples, it is determined whether the extent of overlap has reached a predetermined threshold. For example, a time over lap of 1 (in the present example) may be required to meet the threshold. If the threshold is not met, then a “union” operation is not performed or undertaken.

A first storage device 122 includes first time series data 124 (for times 1 to 3) and second time series data 126 (for times 3 to 5). A second storage device 128 includes third time series data 130 (for times 5 to 7) and fourth time series data 132 (for times 7 to 9). The third query 120 is sent as needed to the first storage device 122 or the second storage device 128 to retrieve as appropriate the first time series data 124, the second time series data 126, and the third time series data 130.

The third query 120 is a union of the first query and the second query. In this respect, the third query 120 includes a first read (to data storage device 122 to get the first and second time series data 124 and 126 from t=1 to 5) and a second read (to get the third time series data 130 from T=5 to 7). In other words, the third query 130 represents a best plan to obtain data for both queries. Once the data is received in response to the third query 120, it is sorted by the sort overlapping data to query module 106. For example, the sort overlapping data to query module 106 may receive all data (the first time series data 124, the second time series data 126, and the third time series data 130) and this data is distributed appropriately in response to the first query 108 and data exclusively for the second query 110).

Thus, the query 120 has a single read to data storage device 122 and a single read to data storage device 128. The two reads occur in parallel. This is different from previous embodiments where two reads would have been made to the first data storage device and another read to the second data storage device. The reduction in the number of reads improves system performance.

As mentioned and once retrieved, the sort overlapping data to query module 106 sorts the data and sends data for the 1 to 5 time periods in response to the first query 108 (i.e., the first time series data 124 and second time series data 126), and data for the 3 to 7 time period in response to the second query 110 (i.e., the second time series data 126 and the third time series data 130). In this way the first time series data 124 and second time series data 126 is returned to the first query 108 as results 140, the second time series data 126 and this time series data 130 is return as results 142 to the second query 110. This is all accomplished with a minimum number of read operations.

It will be appreciated that many different algorithms can be used to implement the modules 104 and 106. However, the exact algorithms used will depend upon, among other things, the nature of the queries, and the nature and identity of any potential overlapping information.

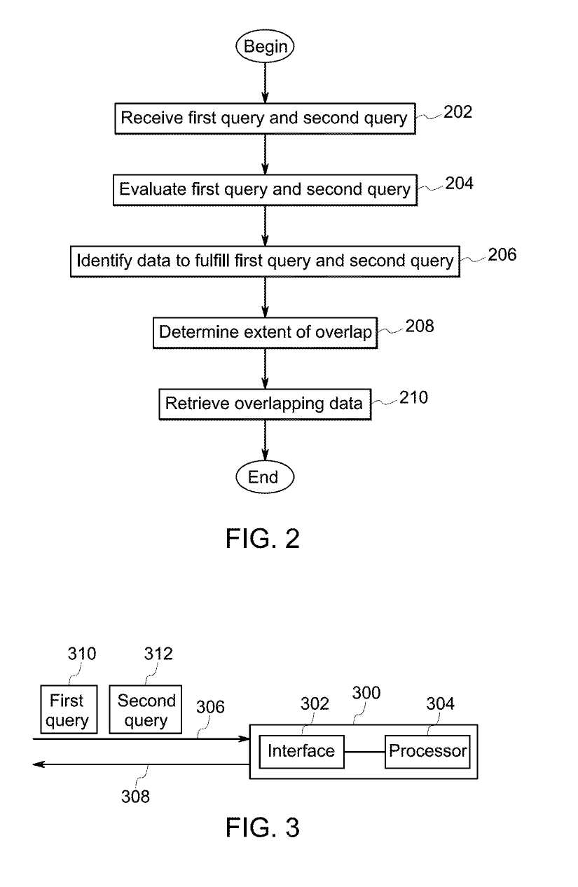

Referring now to FIG. 2, an embodiment for data storage is described. At step 202, a first query and a second query are received. At step 204 the first query and the second query are evaluated. Based upon the evaluating, at step 206, first time series data required to fulfill the first query and second time series data required to fulfill the second query are evaluated. At step 208, an extent of overlap of the first time series data and the second time series data and identifying the overlapping data is determined. At step 210, when the extent of overlap exceeds a predetermined threshold, the overlapping data is retrieved from a plurality of data storage devices in parallel, the data retrieved across all of the plurality of storage devices via a single read operation.

In some aspects, the retrieved data is sorted for disbursement to the first query and the second query. In other aspects, the extent of overlap is determined based upon time ranges specified in the first query and the second query.

In some aspects, the first query or the second query comprises a read query. In other examples, the first query is from a first analytic and the second query is from a second analytic. In other aspects, the query results are retrieved. In some examples, a subset of the results is determined.

Referring now to FIG. 3, a query planner apparatus 300 for executing multiple, time series data queries includes an interface 302 and a processor 304. The interface 302 has an input 306 and an output 308 and the input 306 is configured to receive a first query 310 and a second query 312.

The processor 304 is coupled to the interface 302 and is configured to evaluate the first query 310 and the second query 312 and, based upon the evaluation, identify first time series data required to fulfill the first query and second time series data required to fulfill the second query. The processor 304 is further configured to determine an extent of overlap of the first time series data and the second time series data and identify the overlapping data. The processor 304 is further configured to, when the extent of overlap exceeds a predetermined threshold, retrieve the overlapping data from a plurality of data storage devices in parallel. The data retrieved across all of the plurality of storage devices via a single read operation.

It will be appreciated by those skilled in the art that modifications to the foregoing embodiments may be made in various aspects. Other variations clearly would also work, and are within the scope and spirit of the invention. The present invention is set forth with particularity in the appended claims. It is deemed that the spirit and scope of that invention encompasses such modifications and alterations to the embodiments herein as would be apparent to one of ordinary skill in the art and familiar with the teachings of the present application.

What is claimed is:

1. A method for executing multiple, time series data queries, the method comprising:
receiving a first query and a second query;
evaluating the first query and the second query and, based upon the evaluating, identifying first time series data required to fulfill the first query and second time series data required to fulfill the second query;
determining an extent of overlap of the first time series data and the second time series data and identifying overlapping data; and
when the extent of overlap exceeds a predetermined threshold, retrieving the overlapping data from a plurality of data storage devices in parallel, the data being retrieved across all of the plurality of data storage devices via a single read operation.

2. The method of claim 1 further comprising sorting the retrieved data for disbursement to the first query and the second query.

3. The method of claim 1 wherein the extent of overlap is determined based upon time ranges specified in the first query and the second query.

4. The method of claim 1 wherein the first query or the second query comprise a read query.

5. The method of claim 1 wherein the first query is from a first analytic and the second query is from a second analytic.

6. The method of claim 1 further comprising receiving a first result for the first query and a second result for the second query.

7. The method of claim 6 further comprises determining a subset of the first result or the second result.

8. An apparatus configured to execute multiple, time series data queries, the apparatus comprising:
an interface having an input and an output, the input configured to receive a first query and a second query; and
a processor coupled to the interface, the processor configured to evaluate the first query and the second query and, based upon the evaluation, identify first time series data required to fulfill the first query and second time series data required to fulfill the second query, the processor further configured to determine an extent of overlap of the first time series data and the second time series data and identify the overlapping data, the processor further configured to, when the extent of overlap exceeds a predetermined threshold, retrieve the overlapping data from a plurality of data storage devices in parallel, the data retrieved across all of the plurality of data storage devices via a single read operation.

9. The apparatus of claim 8 wherein the processor is further configured to sort the retrieved data for disbursement to the first query and the second query.

10. The apparatus of claim 8 wherein the extent of overlap is determined based upon time ranges specified in the first query and the second query.

11. The apparatus of claim 8 wherein the first query or the second query comprise a read query.

12. The apparatus of claim 8 wherein the first query is from a first analytic and the second query is from a second analytic.

13. The apparatus of claim 8 wherein the processor is further configured to receive a first result for the first query and a second result for the second query.

14. The apparatus of claim 13 wherein the processor is further configured to determine a subset of the first result and the second result.
